(19) United States
(12) Patent Application Publication
(10) Pub. No.: US 2019/0089054 A1
(43) Pub. Date: Mar. 21, 2019

(54) Techniques and Methods for Adaptive Removal of Analog Phase Errors in Frequency Division Multiplexed Digital Beam-Formers

(71) Applicant: SPAWAR Systems Center Pacific, San Diego, CA (US)

(72) Inventors: Michael P. Civerolo, San Diego, CA (US); Jia-Chi S. Chieh, San Diego, CA (US); Jener S. Chang, San Diego, CA (US); David F. Schwartz, San Diego, CA (US); Aaron Clawson, San Diego, CA (US)

(73) Assignee: United States of America as represented by Secretary of the Navy, San Diego, CA (US)

(21) Appl. No.: 15/708,961

(22) Filed: Sep. 19, 2017

(51) Int. Cl. H01Q 3/38; H01Q 3/42

(52) U.S. Cl. CPC H01Q 3/38; H01Q 3/42

(57) ABSTRACT

A system includes a first low noise amplifier, a second low noise amplifier, a local oscillator, a signal splitter, a first mixer, a second mixer, an analog to digital converter, a digital channelizer and beam-former and a phase error correcting component. The phase error correcting component is configured to generate a first phase error correction coefficient and a second phase error correction coefficient. The digital channelizer and beam-former includes a polyphase filter and a time division multiplexer. The time division multiplexer is configured to output a beam-formed received signal based on a first modified filtered signal and the second modified filtered signal.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 36000, San Diego, Calif., 92152; telephone (619) 553-3001; email: ssc_pac_t2@navy.mil. Reference Navy Case No. 103,288.

### BACKGROUND OF THE INVENTION

Embodiments of the invention relate to reducing front end analog phase errors in digital beamforming arrays.

A directed beam is formed in a phased array antenna (PAA) by introducing phase shifts to the signal arising from each antenna element. The signal from each element is physically isolated and preserved in the analog front end, down-converted from RF to the same low intermediate frequency (IF) for sampling purposes, digitized by a separate analog to digital converter (ADC) and phase shifted so that the beamformed signal adds up coherently in only the desired direction. Phase shifts can be introduced in the digital domain via the multiplication by appropriate beamforming weights in a digital processor.

Frequency division multiplexed (FDM) digital beamforming (DBF) implementations reduce the computational load of generic digital beamforming and reduce the number of data converters needed by frequency multiplexing the signals from the antenna elements to different and distinct intermediate frequencies before digitizing the signals. However, the FDM DBF requires mixing the signal from every antenna element to a different IF and therefore induces a different phase error onto the signal from every antenna element. In real systems, the analog mixers result in unexpected phase errors that may vary with time, temperature, humidity and frequency that are impossible to calibrate out preemptively. The current invention illustrates methods and architectures for an adaptive digital solution to compensate for the phase error (and therefore beam steering error) introduced by the analog mixers in FDM DBF systems.

### SUMMARY OF THE INVENTION

An aspect of the present invention is drawn to a system that includes a first low noise amplifier, a second low noise amplifier, a local oscillator, a signal splitter, a first mixer, a second mixer, an analog to digital converter, a digital channelizer and beam-former and a phase error correcting component. The first low noise amplifier is configured to output a first amplified analog signal based on a received analog antenna signal at a time t₀. The second low noise amplifier is configured to output a second amplified analog signal based on the received analog antenna signal at a time t₁. The local oscillator is configured to output a local analog oscillator signal. The signal splitter is configured to output a first split analog oscillator signal and a second split analog oscillator signal, wherein the first split analog oscillator signal is based on the local analog oscillator signal, the second split analog oscillator signal is based on the local analog oscillator signal and is different from the first split analog oscillator signal. The first mixer is configured to output a first mixed signal based on the first amplified analog signal and the first split analog oscillator signal. The second mixer is configured to output a second mixed signal based on the second amplified analog signal and the second split analog oscillator signal. The analog to digital converter is configured to output a combined digital signal based on the first mixed signal and the second mixed signal. The digital channelizer and beam-former is configured to output a received signal based on the combined digital signal The phase error correcting component is configured to generate a first phase error correction coefficient and a second phase error correction coefficient. The digital channelizer and beam-former includes a polyphase filter and a time division multiplexer. The polyphase filter is configured to receive the combined digital signal, to output a first filtered signal having a first frequency and to output a second filtered signal having a second frequency. The polyphase filter is further configured to receive the first phase error correction coefficient and to output a first modified filtered signal based on the first phase effort correction coefficient and the first filtered signal. The polyphase filter is further configured to receive the second phase error correction coefficient and to output a second modified filtered signal based on the second phase effort correction coefficient and the second filtered signal. The time division multiplexer is configured to output a beam-formed received signal based on the first modified filtered signal and the second modified filtered signal.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIG. 1 illustrates a prior art digital beamforming (DBF) architecture;

FIG. 2 illustrates a prior art frequency division multiplexed (FDM) DBF architecture with a digital polyphase channelizer beamforming core;

FIG. 3 illustrates an example method of correcting error in an FDM DBF architecture in accordance with aspects of the present invention;

FIG. 4A illustrates an FDM DBF architecture with a digital polyphase channelizer beamforming core and a phase error correction component at an initial time t₀ₒ in accordance with aspects of the present invention;

FIG. 4B illustrates an FDM DBF architecture with a digital polyphase channelizer beamforming core and a phase error correction component at a time t₁ in accordance with aspects of the present invention;

FIG. 5A illustrates an FDM DBF architecture with a digital polyphase channelizer beamforming core with a specific non-limiting example of adaptive phase error removal components at initial time t₀ in accordance with aspects of the present invention; and

FIG. 5B illustrates an FDM DBF architecture with a digital polyphase channelizer beamforming core with a specific non-limiting example of adaptive phase error removal components at time t₁ in accordance with aspects of the present invention.

### DETAILED DESCRIPTION OF THE EMBODIMENTS

In a digital system for PAA beamforming, the ability to distinguish between antenna element channels is necessary in order to preserve the phase information of each antenna element. This is because different complex phasing weights are applied to the phase information of each channel in order to form (steer) the beam-formed antenna beam. In traditional receiving DBF architecture, each received signal from an antenna element is down-converted to an identical intermediate frequency (IF) and physically isolated from the other channels by using a different ADC for each antenna element channel. Each channel is down-converted because a typical ADC is unable to sample at a high enough rate to represent RF/microwave frequencies. The digital signal output from each ADC is then beam-formed using a DSP processor to apply a unique complex DBF weight to each channel and to combine (sum) the channels. In frequency division multiplexed digital beamforming (FDM BDF), each received signal from an antenna element is down-converted to a different and distinct IF in order to isolate each channel and allow the multiple channels to be converted using a single ADC. FDM BDF also implements an efficient polyphase channelizer and digital beam-former to process the single digital stream from the ADC and preserve the phase information of each channel for accurate beamforming. The polyphase filter reduces the computation load by splitting the single data stream from the ADC into M down-sampled channels. An M point inverse fast Fourier transform (IFFT) is performed on the M down-sampled data channels in order to recover the M channels associated with each different and distinct IF. The M channels are then weighted with M complex DBF weights and summed to produce the digital beamformed signal. However, the analog front end of the FDM DBF requires mixing the signal from every antenna element to a different IF and therefore induces a different phase error onto the signal from every antenna element. These errors are unexpected, non-uniform and impossible to calibrate out preemptively because they can vary with time, temperature, humidity and frequency.

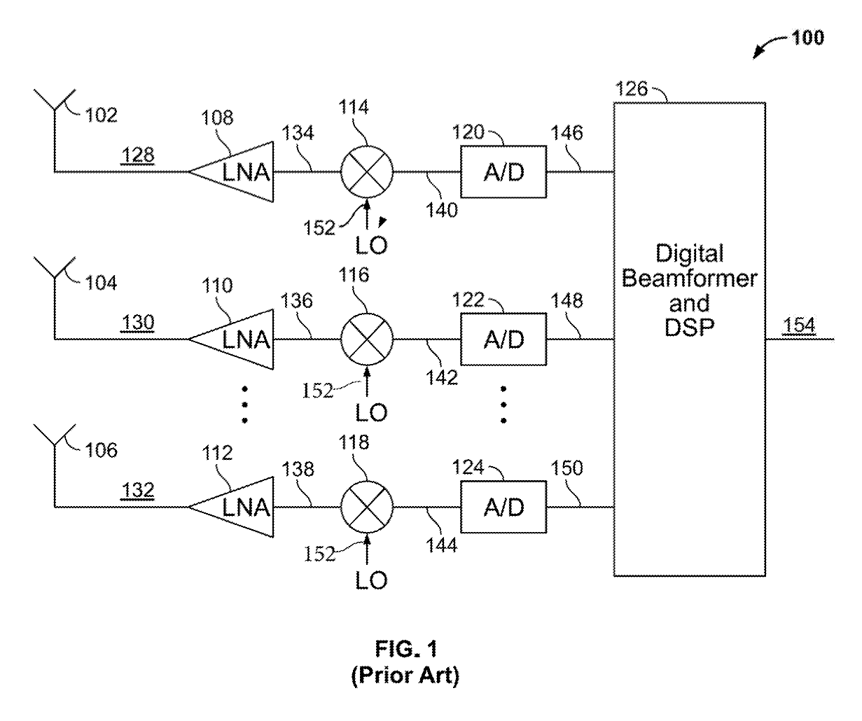

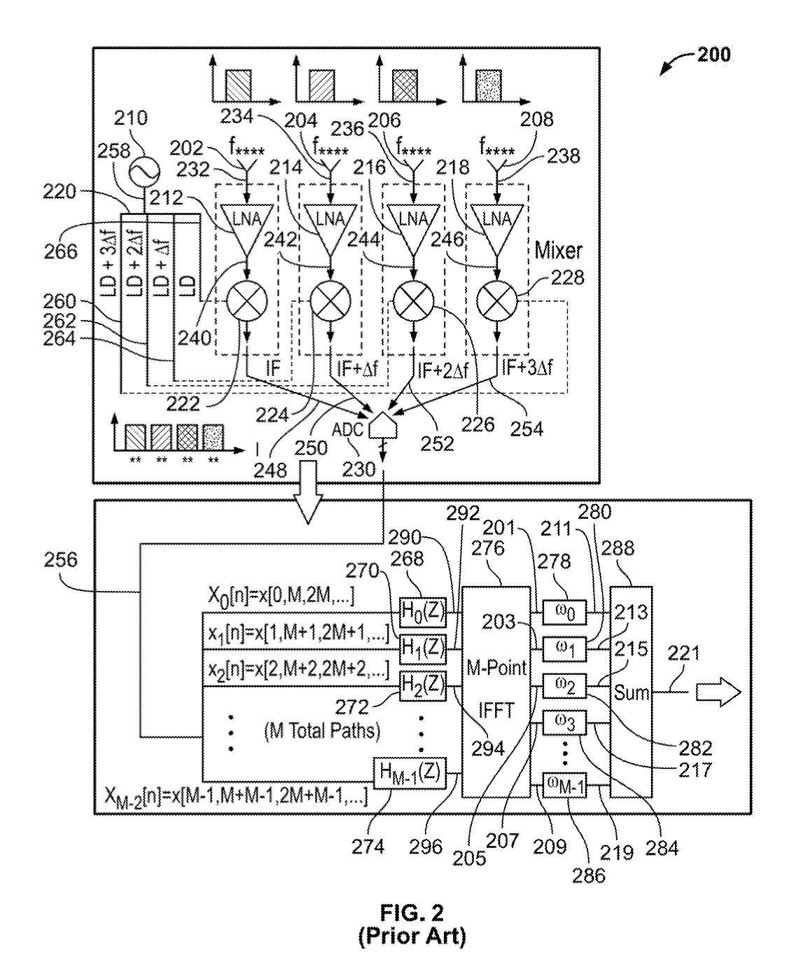

Prior art digital beamforming architectures will now be described with reference to FIGS. 1-2.

Traditional DBF architecture physically isolates each channel corresponding to each antenna element of a PAA in order to preserve phase information. This will now be discussed with reference to FIG. 1.

FIG. 1 illustrates a prior art digital beamforming (DBF) architecture 100.

As illustrated in the figure, prior art DBF architecture 100 includes at least one of an antenna elements 102, 104 and 106, at least one of a low noise amplifier (LNA) 108, 110 and 112, at least one of a mixer 114, 116 and 118, at least one of an analog to digital converter (ADC) 120, 122 and 124 and a digital beam-former and digital signal processor (DSP) 126.

LNA 108 is arranged to receive an analog antenna signal 128 from antenna element 102 and output an amplified analog signal 134. LNA 110 is arranged to receive an analog antenna signal 130 from antenna element 104 and output a second amplified analog signal 136. LNA 112 is arranged to receive an analog antenna signal 132 from antenna element 106 and output a third amplified analog signal 138.

Mixer 114 is arranged to receive amplified analog signal 134 at the RF port and a local analog oscillator signal 152 at the LO port. Mixer 114 is further arranged to output a mixed analog signal 140. Mixer 116 is arranged to receive second amplified analog signal 136 at the RF port and local analog oscillator signal 152 at the LO port. Mixer 116 is further arranged to output a second mixed analog signal 142. Mixer 118 is arranged to receive third amplified analog signal 138 at the RF port and local analog oscillator signal 152 at the LO port. Mixer 118 is further arranged to output a third mixed analog signal 144.

ADC 120 is arranged to receive mixed analog signal 140 and to output a digital signal 146. ADC 122 is arranged to receive second mixed analog signal 142 and to output a second digital signal 148. ADC 124 is arranged to receive third mixed analog signal 144 and to output a third digital signal 150.

Digital beam-former and DSP 126 is arranged to receive digital signal 146, second digital signal 148 and third digital signal 150. Digital beam-former and DSP 126 is further arranged to output a digital beamformed signal 154.

Antenna element 102, antenna element 104 and antenna element 106 are elements of a PAA operable to receive and transmit an RF signal. LNA 108, LNA 110 and LNA 112 are operable to amplify received analog antenna signals without significantly degrading the signal to noise ratio. Mixer 114, mixer 116 and mixer 118 are three-port analog devices operable to modulate an RF analog signal with the application of a local oscillator at the LO port. ADC 120, ADC 122 and ADC 124 are any low-power, high speed, high resolution analog to digital conversion device suitable for beamforming applications. Digital beam-former and DSP 126 is a device or system of devices operable to accept multiple digital channel inputs in order to digitally perform beamforming processes such as, but not limited to, phase shifting and amplitude scaling of each channel and summation/time division multiplexing of all channels. Non-limiting examples may be general purpose DSP chips or dedicated beamforming chips.

In this embodiment, LNA 108 amplifies analog antenna signal 128 and outputs amplified analog signal 134. Amplified analog signal 134 is then modulated by multiplication with local analog oscillator signal 152 at mixer 114. Mixer 114 then outputs mixed analog signal 140. LNA 110 amplifies analog antenna signal 130 and outputs second amplified analog signal 136. Second amplified analog signal 136 is then modulated by multiplication with local analog oscillator signal 152 at mixer 116. Mixer 116 then outputs second mixed analog signal 142. LNA 112 amplifies analog antenna signal 132 and outputs third amplified analog signal 138. Third amplified analog signal 138 is then modulated by multiplication with local analog oscillator signal 152 at mixer 118. Mixer 118 then outputs third mixed analog signal 144.

Amplified analog signal 134, second amplified analog signal 136 and third amplified analog signal 138 are RF signals that are down-converted to a low-IF because analog to digital converters often cannot sample at a sufficient rate to represent RF/microwave frequencies. In this example, all channels are down-converted to an identical low-IF. To accomplish this, amplified analog signal 134 is multiplied at mixer 114 by local analog oscillator signal 152, second amplified analog signal 136 is multiplied at mixer 116 by local analog oscillator signal 152 and third amplified analog signal 138 is multiplied at mixer 118 by local analog oscillator signal 152. Mixed analog signal 140, second mixed analog signal 142 and third mixed analog signal 144 are then ready to be digitized.

Since each channel is now at the same low-IF, a separate A/D is required for each channel. ADC 120 creates a digital representation of mixed analog signal 140 and outputs digital signal 146. ADC 122 creates a digital representation of second mixed analog signal 142 and outputs second digital signal 148. ADC 124 creates a digital representation of third mixed analog signal 144 and outputs third digital signal 150. Digital signal 146, second digital signal 148 and third digital signal 150 are then all sent to Digital beam-former and DSP 126 for processing. Digital beam-former and DSP 126 outputs digital beamformed signal 154.

Prior art DBF architecture 100 uses a separate ADC for each channel associated with each PAA antenna element in order to physically isolate the channels and preserve phase information. Because prior art DBF architecture 100 requires a distinct ADC for each antenna channel, each ADC is only required to sample at twice the channel signal's bandwidth but the additional requires a large physical area and high power consumption.

A more recent prior art DBF architecture uses frequency division multiplexed (FDM) digital beamforming (DBF) architecture. FDM DBF architecture frequency encodes each antenna channel and therefore only requires a single ADC. The FDM DBF architecture also has a digital polyphase channelizer beamforming core, which allows channelizing/down sampling of the single digital stream of ADC output. This will be further described with reference to FIG. 2.

FIG. 2 illustrates a prior art FDM DBF architecture 200 with a digital polyphase channelizer beamforming core.

As shown in the figure, FDM DBF architecture 200 includes at least one of an antenna element 202, 204, 206 and 208, at least one of an LNA 212, 214, 216 and 218, a local oscillator (LO) 210, a splitter 220, at least one of a mixer 222 224, 226 and 228, an ADC 230, at least one of a filter 268, 270, 272 and Mₜₕ filter 274, an inverse fast Fourier transform (IFFT) component 276, at least one of a weighting component 278, 280, 282, 284, and Mₜₕ weighting component 286 and a time division multiplexer (TDM) 288.

LNA 212 is arranged to receive an analog antenna signal 232 from antenna element 202 and output an amplified analog signal 240. LNA 214 is arranged to receive a second analog antenna signal 234 from antenna element 204 and output a second amplified analog signal 242. LNA 216 is arranged to receive a third analog antenna signal 236 from antenna element 206 and output a third amplified analog signal 244. LNA 218 is arranged to receive a fourth analog antenna signal 238 from antenna element 208 and output a fourth amplified analog signal 246.

Splitter 220 is arranged to receive a local analog oscillator signal 258 from LO 210. Splitter 220 is further arranged to output a split analog oscillator signal 260, a split analog oscillator signal 262, a split analog oscillator signal 264 and a split analog oscillator signal 266.

Mixer 222 is arranged to receive amplified analog signal 240 at the RF port and split analog oscillator signal 266 at the LO port. Mixer 222 is further arranged to output a mixed analog signal 248. Mixer 224 is arranged to receive second amplified analog signal 242 at the RF port and split analog oscillator signal 264 at the LO port. Mixer 224 is further arranged and to output a mixed analog signal 250. Mixer 226 is arranged to receive third amplified analog signal 244 at the RF port and split analog oscillator signal 262 at the LO port. Mixer 226 is further arranged to output a mixed analog signal 252. Mixer 228 is arranged to receive fourth amplified analog signal 246 at the RF port and split analog oscillator signal 260 at the LO port. Mixer 228 is further arranged to output a mixed analog signal 254.

ADC 230 is arranged to receive mixed analog signal 248, mixed analog signal 250, mixed analog signal 252 and mixed analog signal 254. ADC 230 is further arranged to output a combined digital signal 256.

Filter 268, filter 270, filter 272 and Mₜₕ filter 274 are arranged to receive a combined digital signal 256. Filter 268 is further arranged to output a filtered signal 290. Filter 270 is further arranged to output a filtered signal 292. Filter 272 is further arranged to output a filtered signal 294. Mₜₕ filter 274 is further arranged to output an Mₜₕ filtered signal 296.

IFFT component 276 is arranged to receive filtered signal 290, filtered signal 292, filtered signal 294 and Mₜₕ filtered signal 296. IFFT component 276 is further arranged to output a transformed signal 201, a transformed signal 203, a transformed signal 205, a transformed signal 207 and an Mₜₕ transformed signal 209.

Weighting component 278 is arranged to receive transformed signal 201 and is further arranged to output a weighted signal 211. Weighting component 280 is arranged to receive transformed signal 203 and is further arranged to output a weighted signal 213. Weighting component 282 is arranged to receive transformed signal 205 and is further arranged to output a weighted signal 215. Weighting component 284 is arranged to receive transformed signal 207 and is further arranged to output a weighted signal 217. Mₜₕ weighting component 286 is arranged to receive Mₜₕ transformed signal 209 and is further arranged to output an Mₜₕ weighted signal 219.

TDM 288 is arranged to receive weighted signal 211, weighted signal 213, weighted signal 215, weighted signal 217 and Mₜₕ weighted signal 219. TDM 288 is further arranged to output a digital beamformed signal 221.

Antenna element 202, antenna element 204, antenna element 206 and antenna element 208 are elements of a PAA operable to receive an RF signal. LNA 212, LNA 214, LNA 216 and LNA 218 are operable to amplify received analog antenna signals without significantly degrading the signal to noise ratio. Splitter 220 is any device operable to split a sinusoidal signal into multiple signals, each at a distinct, equidistant frequency. Mixer 222, mixer 224, mixer 226 and mixer 228 are three-port analog devices operable to modulate an RF analog signal with the application of a local oscillator signal at the LO port. ADC 230 is a low-power, high speed, high resolution analog to digital conversion device operable to sample at 2×M the instantaneous signal bandwidth, where M is the number of antenna elements.

Filter 268, filter 270, filter 272 and Mₜₕ filter 274 make up a polyphase filter, an M-path partitioned filter operable to channelize a combined digital signal by down-sampling at a rate fₛ/M, where fₛ is the sampling rate of the combined signal and M is the number of channels. IFFT component 276 is operable to perform an M-point IFFT and output M frequency channels. Weighting component 278, weighting component 280, weighting component 282, weighting component 284 and Mₜₕ weighting component 286 are operable to multiply a complex digital signal by a complex phase weight ωᵢ, where i is the i^{th} weighting component. TDM 288 is a device or system of devices operable to, but not limited to, transmit multiple digital channel inputs as a single signal based on signal segment timing. Non-limiting examples may be general purpose DSP chips or dedicated TDM chips.

In this embodiment, LNA 212 amplifies analog antenna signal 232 and outputs amplified analog signal 240. LNA 214 amplifies second analog antenna signal 234 and outputs second amplified analog signal 242. LNA 216 amplifies third analog antenna signal 236 and outputs third amplified analog signal 244. LNA 218 amplifies fourth analog antenna signal 238 and outputs fourth amplified analog signal 246.

In order to provide a distinguishing factor (frequency) for each channel associated with each antenna element, frequency division multiplexing (FDM) is used. In FDM, the total bandwidth available is divided into a series of non-overlapping frequency sub-bands, each of which is used to carry a separate signal. To accomplish this, local analog oscillator signal 258 of frequency f_{LO} is divided by splitter 220 into four split analog oscillator signals, split analog oscillator signal 266 at frequency f_{LO}, split analog oscillator signal 264 at frequency f_{LO}+Δf split analog oscillator signal 262 at frequency f_{LO}+2Δf and split analog oscillator signal 260 at frequency f_{LO}+3Δf.

Amplified analog signal 240 is modulated by multiplication with split analog oscillator signal 266 at mixer 222, which outputs mixed analog signal 248. Second amplified analog signal 242 is modulated by multiplication with split analog oscillator signal 264 at mixer 224, which outputs mixed analog signal 250. Third amplified analog signal 244 is modulated by multiplication with split oscillator signal 262 at mixer 226, which outputs mixed analog signal 252. Fourth amplified analog signal 246 is modulated by multiplication with split oscillator signal 260 at mixer 228, which outputs mixed analog signal 254.

In this way, each amplified analog signal is down-converted to a distinct low-IF frequency in order to isolate the antenna channels from each other. Split analog oscillator signal 266 down-converts amplified analog signal 240 at mixer 222 to low-IF, F₁, wherein F₁=f_{1F}=|f_{LO}−f_{RF}|(1). Split analog oscillator signal 264 down-converts second amplified analog signal 242 at mixer 224 to low-IF, F₂, where:

F₂=f_{1F}+Δf=|(f_{LO}+Δf)−f_{RF}|. (2)

Split analog oscillator signal 262 down-converts third amplified analog signal 244 at mixer 226 to low-IF, F₃, where:

F₃=f_{1F}+2Δf=|(f_{LO}2Δf)−f_{RF}|. (3)

Split analog oscillator signal 260 down-converts fourth amplified analog signal 246 at mixer 228 to fourth low-IF, F₄, where:

F₄=f_{1F}+3Δf =|(f_{LO}+3Δf)−f_{RF}|. (4)

After down-converting, mixed analog signal 248 is the analog signal from antenna element 202 modulated at F₁, mixed analog signal 250 is the analog signal from antenna element 204 modulated at F₂, mixed analog signal 252 is the analog signal from antenna element 206 modulated at F₃ and mixed analog signal 254 is the analog signal from antenna element 208 modulated at F₄.

Now that each analog signal from each antenna element is uniquely represented and encoded, a single ADC, ADC 230, can be used to create a digital representation of all M (in this example, M=4) analog antenna signals in one aggregate signal, combined digital signal 256.

Since each of the mixed analog signals at F₁, F₂, F₃, and F₄ occupies a certain bandwidth, the total bandwidth of the overall spectrum has been increased. For this reason, ADC 230 samples at eight times the signal bandwidth (M=4). For example, if the instantaneous signal bandwidth is 100 MHz, ADC 230 should be capable of sampling at 800 Mbps.

To overcome this difficulty, combined digital signal 256 is channelized using an M-path partitioned filter consisting of filter 268, filter 270, filter 272 and Mₜₕ filter 274, where M is the number of frequency channels in combined digital signal 256.

An M-path partitioned filter partitions a group of filter coefficients among M channels to save processing resources. For example, if M=4, and there were four filter coefficients, normally there would be four different coefficient filters, each filtering combined digital signal 256. A 4-path partitioned filter would place the first coefficient on a path 1, the second coefficient on a path 2, the third coefficient on a path 3 and the fourth coefficient on a path 4. If the combined digital signal is x(n), the first coefficient would sample x(0, 4, 8, . . . ), the second coefficient would sample x(1, 5, 9, . . . ), the third coefficient would sample x(2, 6, 10, . . .) and the fourth coefficient would sample x(3, 7, 11, . . . ). For M paths and M coefficients, the coefficients would be partitioned among M filters so that the first filter (first coefficient) would sample x(0, M, 2M, . . . ), the second filter (second coefficient) would sample x(1, M+1, 2M+1, . . . ) the third filter (third coefficient) would sample x(2, M+2, 2M+2, . . . ) and the Mₜₕ filter (Mₜₕ coefficient) would sample x(M−1, M+M−1, 2M+M−1, . . . ). Each channel is down-sampled at a rate fₛ/M, where fₛ is the original sampling rate and has a different starting sample.

Referring to the figure, filter 268 samples x₀(n)=x(0, M, 2M, . . . ), filter 270 samples x₁(n)=x(1, M+1, 2M+1,. . . ), filter 272 samples x₂(n)=(2, M+2, 2M+2, . . . ) and Mₜₕ filter 274 samples x_{M-}1(n)=x(M−1, M+M−1, 2M+M−1, . . . ). Each of the four channels is down-sampled at a rate fₛ/4.

IFFT component 276 performs an M-point IFFT on filtered signal 290, filtered signal 292, filtered signal 294 and Mₜₕ filtered signal 296. This produces M independent frequency channels, transformed signal 201, transformed signal 203, transformed signal 205, transformed signal 207 and Mₜₕ transformed signal 209.

Once the M independent frequency channels have been recovered by the IFFT, each channel should be weighted properly in order to form the desired received signal. To accomplish this, each of the M frequency channels is multiplied by a complex DBF weight in order to shift the phase by the necessary amount to form the desired received antenna beam. Referring to the figure, transformed signal 201 is multiplied by ω₀, transformed signal 203 is multiplied by ω₁, transformed signal 205 is multiplied by ω₂, transformed signal 207 is multiplied by ω₃ and Mₜₕ transformed signal 209 is multiplied by ω_{M-1}. Weighted signal 211, weighted signal 213, weighted signal 215 and weighted signal 217 are then summed by TDM 288 to produce digital beamformed signal 221.

The FDM DBF architecture of FIG. 2 is an improvement over the traditional DBF architecture of FIG. 1 in that it reduces the amount of hardware/physical space and processing resources required. However, prior art FDM DBF architecture 200 does not compensate for unintended phase errors introduced by the analog front end. As discussed above, FDM DBF architecture requires mixing the analog signal from every antenna element with a different local analog oscillator signal in order to down-convert each analog antenna signal to a different and distinct low-IF before digitizing the signals. This differs from standard DBF architecture 100 in that front end analog mixers would be fed by the same local analog oscillator signal and would therefore all have the same phase errors which would cancel out during digital beamforming. In FDM DBF architecture, these phase errors would not cancel out and would result in directional errors of the digitally formed beam. In real systems, analog mixers are nonlinear devices; down-converting each analog antenna signal to a different low-IF frequency as in FDM DBF architecture 200 can result in unexpected, undesired and nonuniform analog phase errors across the analog antenna signals from each of the antenna elements. In addition, this nonuniform analog phase error may vary over time, frequency and temperature/humidity. As a result, this phase error is difficult to calibrate out, requiring that a FDM DBF system compensate for analog phase error in the digital realm.

What is needed is a new FDM DBF architecture that provides an adaptive digital solution to compensate for the analog non-uniform phase errors introduced in the analog front end of FDM DBF architecture. Because the imperfect individual local analog oscillator signals in the FDM DBF architecture introduce non-uniform (from array element signal to array element signal) analog phase errors, it is important to introduce a block in the system to compensate for these errors.

Aspects of the present invention overcome the drawbacks of the prior art FDM DBF system discussed above by providing an adaptive digital solution to compensate for the phase error (and therefore beam steering error) introduced by the analog mixers in frequency multiplexed digital beam-formers.

In accordance with aspects of the present invention, a new FDM DBF architecture introduces an additional digital block that adaptively and continuously seeks to find error compensation while never degrading the desired digital beams and not requiring feedback from the analog front end. The new block only takes up the digital resources of another digital beam with an additional random number generator.

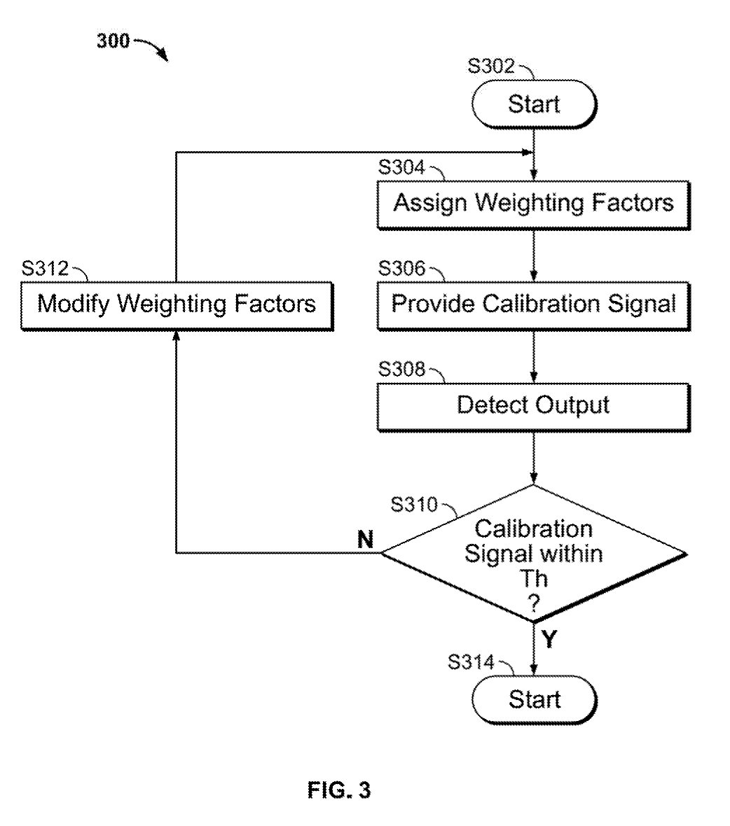

Example embodiments of FDM DBF architecture in accordance with aspects of the present invention will now be described with reference to FIGS. 3-5B.

The process of adaptively correcting front end analog phase errors in a FDM DBF system will now be described with reference to FIG. 3.

FIG. 3 illustrates an example method 300 of correcting front end analog phase error in an FDM DBF architecture in accordance with aspects of the present invention.

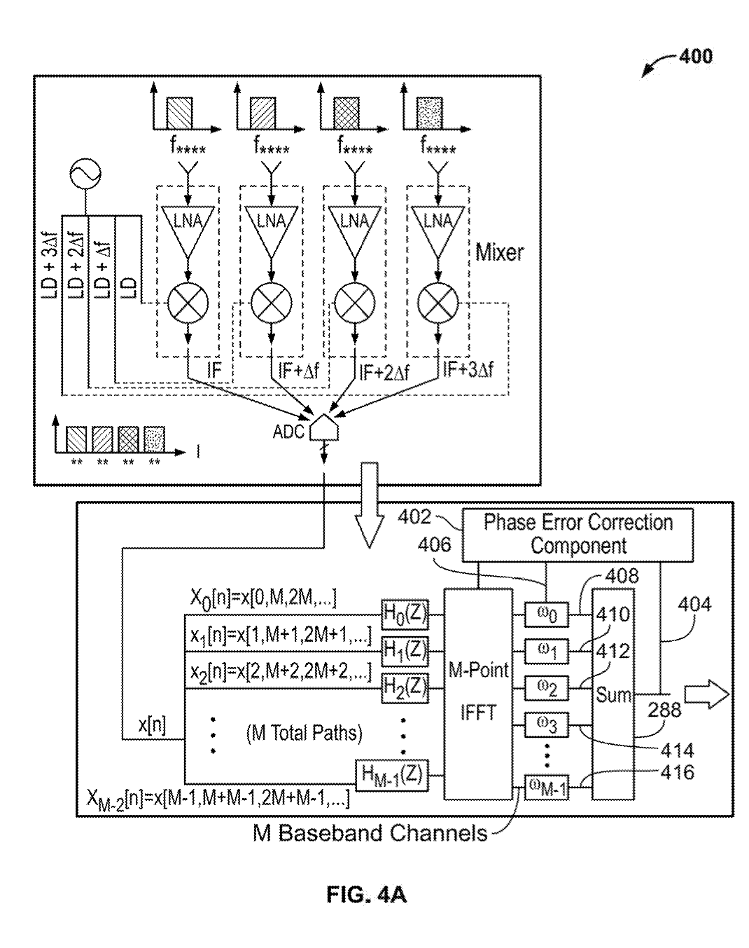

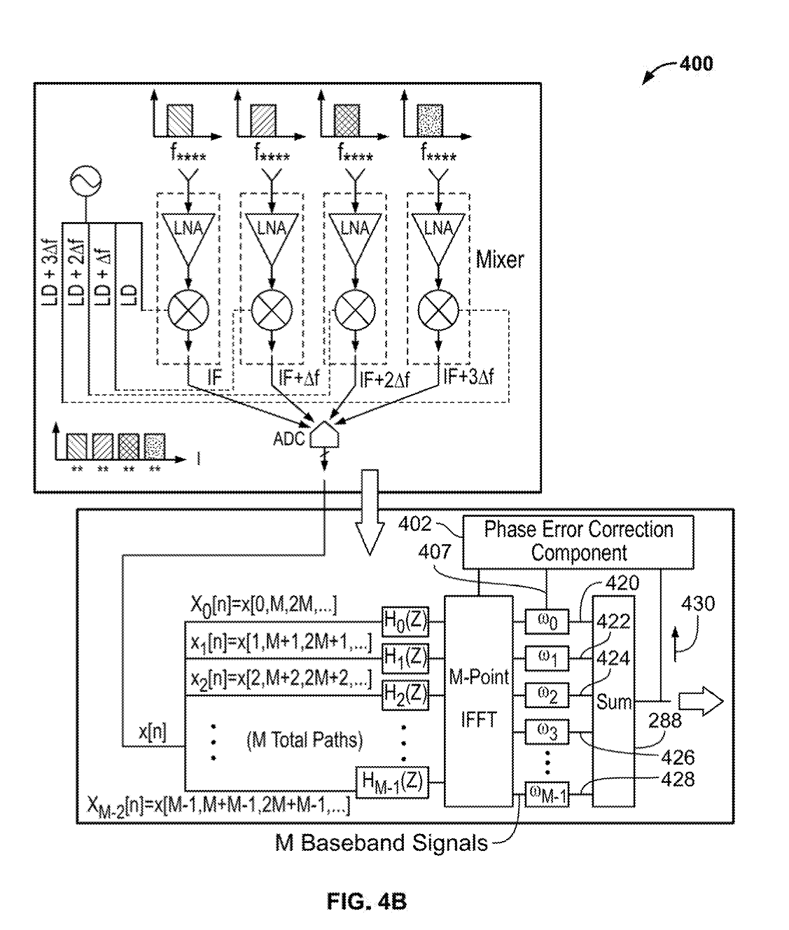

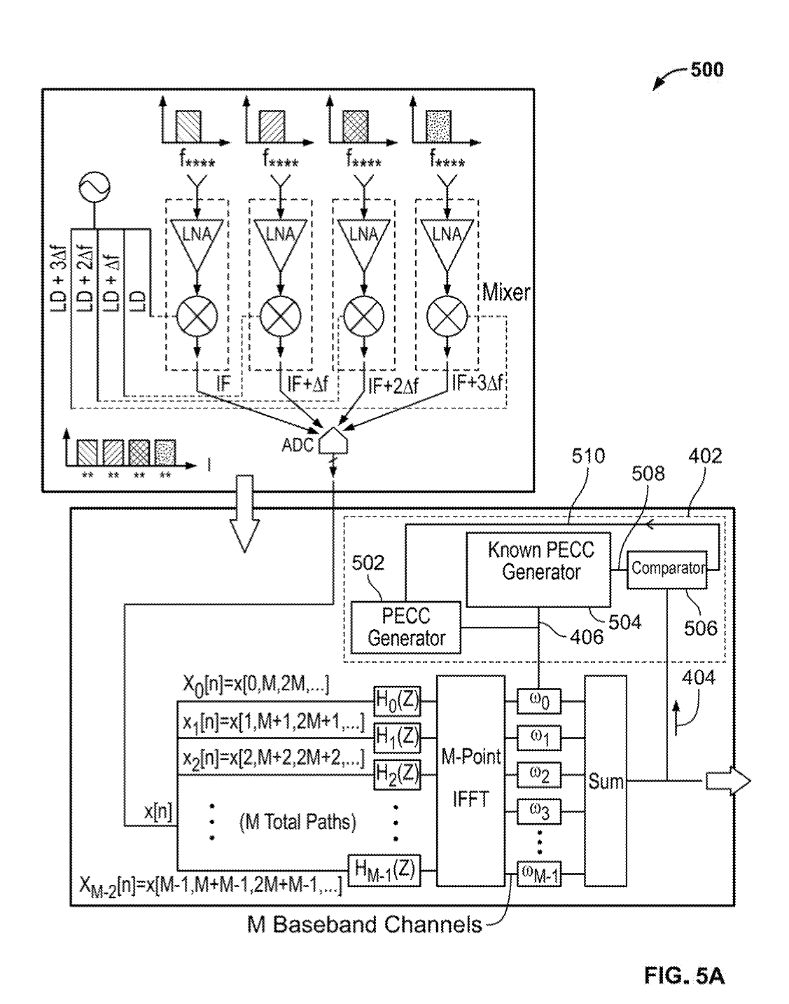

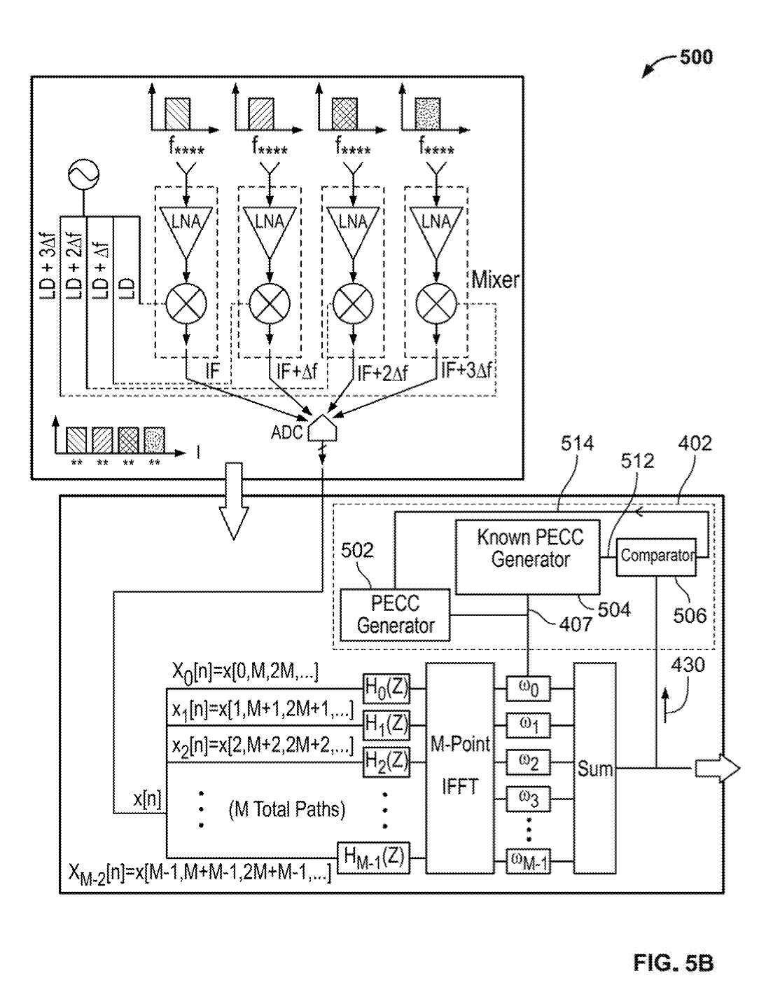

As shown in the figure, method 300 starts (S302) and phase error correction coefficients (PECCs) are assigned (S304). This will be discussed in greater detail with reference to FIGS. 4A and 5A.

An FDM DBF architecture with an adaptive digital phase error correction block at the initial calibration stage (t₀) in accordance with aspects of the present invention will now be described with reference to FIG. 4A.

FIG. 4A illustrates an FDM DBF architecture 400 with a digital polyphase channelizer beamforming core using a phase error correction component at an initial time t₀ in accordance with aspects of the present invention.

As shown in the figure, FDM DBF architecture 400 includes all the elements of FIG. 2 with the addition of a phase error correction component 402.

TDM 288 is arranged to receive a plurality of modified filter signals, a sample of which are indicated as a modified filter signal 408, a modified filter signal 410, a modified filter signal 412, a modified filter signal 414 and a modified filter signal 416. TDM 288 is further arranged to output a beamformed received signal 404.

Phase error correction component 402 is arranged to output a set of PECCs 406 and to receive beamformed received signal 404.

Phase error correction component 402 may be any device or system operable to adaptively correct front end analog phase error in an FDM DBF system in the digital realm.

In this embodiment, at initial time t₀, phase error correction component 402 assigns initial PECCs by some method, for example, by generating an initial set of phase corrections to add to an initial calibration set of M complex DBF weights as a first attempt at compensating for front end analog phase error.

FDM DBF architecture 400 illustrates a generalized phase correction component block for analog error removal. A FDM DBF architecture with a specific non-limiting example of a digital phase error removal block at an initial time t₀ in accordance with aspects of the present invention will now be described with reference to FIG. 5A.

FIG. 5A illustrates an FDM DBF architecture 500 with a digital polyphase channelizer beamforming core with a specific non-limiting example of adaptive phase error removal components at initial time t₀ in accordance with aspects of the present invention.

FIG. 5A includes all the elements of FIG. 4A. As illustrated by the figure, phase error correction component 402 includes a PECC generator 502, a known PECC generator 504 and a comparator 506.

In this example, PECC generator 502, known PECC generator 504 and comparator 506 are illustrated as individual devices. However, in some embodiments, at least two of PECC generator 502, known PECC generator 504 and comparator 506 may be combined as a unitary device. Further, in some embodiments, at least one of PECC generator 502, known PECC generator 504 and comparator 506 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Known PECC generator 504 is arranged to output a calibration signal 508 and receive the set of PECCs 406. Comparator 506 is arranged to accept calibration signal 508 and beamformed received signal 404. Comparator 506 is further arranged to output a compared signal 510.

Phase error correction coefficient generator 502 is arranged to accept compared signal 510 and output the set of PECCs 406.

Known PECC generator 504 is a device or system of devices operable to perform digital beamforming on M digital channels and perform functions, non-limiting examples of which include, addition/multiplication of complex numbers and pseudo-random number generation. Comparator 506 is a device or system of devices operable to determine whether |A−B|≤th, where A and B are the binary values being compared and th is a predetermined threshold within comparator 506. Phase error correction coefficient generator 502 is a device or system of devices operable to output a set of values based on, but not limited to, the state of comparator 506.

In this embodiment, at initial time t₀, known PECC generator 504 assigns initial PECCs by generating an initial set of phase corrections and adding those to an initial calibration set of M complex DBF weights. For example, an initial calibration set of M complex DBF weights could be a known set of M complex DBF weights that have been previously determined to produce an accurately pointed digital beam. The digital beam associated with the initial calibration set ofM complex DBF weights is the known beam. The initial set of phase corrections could be, for example, a set of M random numbers produced by a pseudo-random number generator.

Returning to FIG. 3, after PECCs have been assigned (S304), a calibration signal is provided (S306). This will be discussed in greater detail with reference to FIG. 5A.

Referring now to FIG. 5A, known PECC generator 504 multiplies the PECCs assigned at t₀ (the initial calibration set of M complex DBF weights plus an initial set of phase corrections) by the M baseband channels to generate a modified beamformed signal, calibration signal 508. At t₀, calibration signal 508 is a first attempt at producing a more accurately pointed digital beam than the known beam.

Returning to FIG. 3, after the calibration signal has been provided (S306), the output is detected (S308). This will be discussed in greater detail with reference to FIG. 4A and FIG. 5A.

Referring to FIG. 4A, at t₀, the M baseband channels are multiplied by the initial calibration set of M complex DBF weights, ω₀, ω₁, ω₂, . . . , to produce M phase shifted channels, modified filtered signal 408, modified filtered signal 410, modified filtered signal 412, modified filtered signal 414 and modified filtered signal 416. The M phase shifted channels are summed at TDM 288 to produce the output at t₀, beamformed received signal 404. Beamformed received signal 404 is the known beam and is initially the best-known solution for the analog phase errors at t₀. The output at t₀ is detected by phase error correction component 402.

Referring now to FIG. 5A, the output at t₀, beamformed received signal 404 is detected at comparator 506. Comparator 506 also detects calibration signal 508.

Returning to FIG. 3, after the output is detected (S308), it is determined whether the calibration signal is within a predetermined threshold of the known beam (S310). This will be discussed in greater detail with reference to FIG. 5A.

Referring to FIG. 5A, comparator 506 compares the output at t₀, the known beam, beamformed received signal 404, with calibration signal 508, the first attempt at producing a more accurately pointed digital beam than the known beam. Comparator 506 determines whether the absolute value of the difference between beamformed received signal 404 and calibration signal 508 is within a predetermined threshold. As such, comparator 506 determines whether |A−B|≤th, wherein in this case, beamformed received signal 404 is A, calibration signal 508 is B and th is predetermined.

Compared signal 510 has a first state, 1, indicating when |A−B|≤th and a second state, 0, indicating when |A−B|>th. A compared signal 510 of 1 indicates that beamformed received signal 404 is sufficiently close to calibration signal 508, such that a steered beam will be sufficiently accurate. On the other hand, a compared signal 510 of 0 indicates that beamformed received signal 404 is insufficiently close to calibration signal 508, such that a steered beam will be insufficiently accurate and that the phase correction coefficients require additional adjustment.

Returning to FIG. 3, if it is determined that the calibration signal is not within the predetermined threshold of the known beam (N at S310), then the PECCs are modified (S312). This will be discussed in greater detail with reference to FIG. 4B and FIG. 5B.

FIG. 4B illustrates an FDM DBF architecture 400 with a digital polyphase channelizer beamforming core using a phase error correction component at a time t₁ in accordance with aspects of the present invention. TDM 288 is arranged to receive a modified filter signal 420, a modified filter signal 422, a modified filter signal 424, a modified filter signal 426 and a modified filter signal 428. TDM 288 is further arranged to output a beamformed received signal 430.

Phase error correction component 402 is arranged to output the set of PECCs 407 and to receive beamformed received signal 430.

If phase error correction component 402 determines that the initial set of phase corrections generated at t₀ result in a less accurately pointed digital beam, phase error correction component 402 will output a new set of PECCs 407 to be added to the initial calibration set of M complex DBF weights.

FIG. 5B illustrates the FDM DBF architecture 500 with a specific non-limiting example of adaptive phase error removal components at time t₁ in accordance with aspects of the present invention.

Known PECC generator 504 is arranged to output a calibration signal 512 and receive PECC 407. Comparator 506 is arranged to accept calibration signal 512 and beamformed received signal 430. Comparator 506 is further arranged to output a compared signal 514.

Phase error correction coefficient generator 502 is arranged to accept compared signal 514 and output PECC 407.

As discussed above, if comparator 506 determines that |A−B|>th, wherein in this case, beamformed received signal 404 is A, calibration signal 508 is B then calibration signal 508 is insufficiently close to beamformed received signal 404. Therefore, calibration signal 508 corresponds to a less accurately pointed beam than the known beam.

Comparator 506 outputs compared signal 514, indicating that |A−B|>th. PECC generator 502 will then output a new set of PECCs 407 to all the beam-formers. The current calibration set of M complex DBF weights is now the initial calibration set of M complex DBF weights plus the current set of phase corrections, the set of PECCs 407.

Returning to FIG. 3, after the PECCs have been modified (S312), new PECCs are assigned (S304). This will be described in greater detail with reference to FIG. 4B and FIG. 5B.

At time t₁, phase error correction component 402 assigns PECCs by some method, for example, by generating a new set of phase corrections and adding those to the current calibration set ofM complex DBF weights.

In this embodiment, at time tₗ, known PECC generator 504 assigns new PECCs by generating a new set of phase corrections and adding those to the current calibration set of M complex DBF weights. For example, as discussed above, a new set of phase corrections could be produced by known PECC generator 504 using a pseudo-random number generator.

Returning to FIG. 3, after PECCs have been assigned (S304), a calibration signal is provided (S306). This will be discussed in further detail with reference to FIG. 5B.

As illustrated by FIG. 5B, known PECC generator 504 multiplies the PECCs 407 assigned at t₁ (the current calibration set ofM complex DBF weights plus a new set of phase corrections generated by PECC generator 504 at t₁), by the M baseband channels to generate a modified beamformed signal, calibration signal 512.

Returning to FIG. 3, after the calibration signal has been provided (S306), the output is detected (S308). This will be described in greater detail with reference to FIG. 4B and FIG. 5B.

Referring to FIG. 4B, at t₁, the M baseband channels are multiplied by the current calibration set of M complex DBF weights, ω₀, ω₁, ω₂, . . . , ω_{M-1}, to produce M phase shifted channels, modified filtered signal 420, modified filtered signal 422, modified filtered signal 424, modified filtered signal 426 and modified filtered signal 428. The M phase shifted channels are summed at TDM 288 to produce the output at t₁, beamformed received signal 430, the known beam. This output at t₁ is detected by phase error correction component 402.

Referring to FIG. 5B, the output at t₁, beamformed received signal 430 is detected at comparator 506. Comparator 506 also detects calibration signal 512, the modified beamformed signal at t₁.

Returning to FIG. 3, after the output is detected (S308), it is determined whether the calibration signal is greater than the output (S310).

Referring to FIG. 5B, comparator 506 compares the output at t₁, the known beam, beamformed received signal 430, with calibration signal 512, the second attempt at producing a more accurately pointed digital beam than the known beam. Comparator 506 determines whether the absolute value of the difference between beamformed received signal 430 and calibration signal 512 is within the predetermined threshold. As such, comparator 506 determines whether |A−B|≤th, wherein in this case, beamformed received signal 430 is A, calibration signal 512 is B and th is predetermined.

Compared signal 510 has a first state, 1, indicating when |A−B|≤th and a second state, 0, indicating when |A−B|>th. A compared signal 514 of 1 indicates that beamformed received signal 430 is sufficiently close to calibration signal 512, such that a steered beam will be sufficiently accurate. On the other hand, a compared signal 514 of 0 indicates that beamformed received signal 430 is insufficiently close to calibration signal 512, such that a steered beam will be insufficiently accurate and that the phase correction coefficients require additional adjustment.

Returning to FIG. 3, if it is determined that the calibration signal is not within the predetermined threshold of the known beam (N at S310), then the PECCs are modified (S312) in the same manner discussed above.

Alternatively, if it is determined that the calibration signal is within the predetermined threshold of the known beam (Y at S310), then method 300 stops.

Referring to FIG. 5B, in the case where compared signal 514 is 1, thus indicating that beamformed received signal 430 is sufficiently close to calibration signal 512, the steered beam will be sufficiently accurate. Therefore, the known beam is still the best solution to compensate for analog front-end phase errors. In this case, PECCs 407 are used at the calibration set of M complex DBF weights.

However in the case where compared signal 514 is 0, thus indicating that beamformed received signal 430 is insufficiently close to calibration signal 512, the steered beam will be insufficiently accurate. Therefore, the loop of generating new PECCs comparing the output with the predetermined threshold th is repeated until a sufficient set of PECCs is generated to compensate for analog front-end phase errors. In this manner, PECC generator 502, known PECC generator 504 and comparator 506 are arranged as an adaptive feedback system to minimize compared signal 514.

In summary, digital beam-formers digitize the signal from each antenna element of a PAA (in the receive mode) and apply complex phase weights to each signal so that the radiation from a particular direction adds coherently. In an ideal system, the only phase weighting that would need to be applied would compensate for spatial separation between antenna array elements. However, in real systems, the analog mixers used to frequency multiplex the antenna signals in the front end can result in unexpected phase errors in the signal from each antenna element. This results in pointing errors in the radiation beam being formed by the array.

Frequency division multiplexing is used to offer a distinguishing factor for each channel so that one analog to digital converter supports a plurality of antenna elements in a digital beamforming antenna array. A combined digital signal from the analog to digital converter can then be down-sampled by polyphase filtering and the signal spectrum channelized by an inverse fast Fourier transform (IFFT). This reduces the overall cost, weight, size and consumed power of the required circuitry when compared to standard digital beamforming, which requires a separate analog to digital converter for each antenna element.

In addition, the polyphase filtering of the combined digital signal from the single analog to digital converter is used to reduce computation load and processing resources. However, the frequency multiplexed digital beam-former requires mixing the analog signal from every antenna element to a different intermediate frequency. These analog mixers, which have nonlinear properties, are then being fed by different local oscillator signals, resulting in nonuniform phase errors across the signals from the PAA's antenna elements. This differs from the standard digital beamforming architecture whose front end analog mixers would all be fed by the same local oscillator and would all have the same phase errors which would cancel out during beamforming. In a frequency division multiplexed digital beamforming system, the nonuniform phase errors introduced by the analog mixers can fluctuate with time, temperature and frequency and are therefore impossible to calibrate out preemptively. These non-uniform phase errors will degrade the fidelity of the digital beam by resulting in directional errors.

In a present embodiment of the invention, an adaptive digital solution to compensate for the non-uniform analog front end phase error (and therefore beam steering error) introduced by the analog mixers in a frequency division multiplexed digital beam-former is presented. This invention results in an architecture that contains an additional digital block that adaptively and continuously seeks to find error compensation while never degrading the desired digital beams and not requiring feedback from the analog front end. The new block only takes up the digital resources of another digital beam and allows for the digital beam-formers to be more accurately pointed (spatially). Since frequency division multiplexed digital beam-formers are a new technology, this architecture provides a solution to one of the first known issues with frequency division multiplexed digital beamforming.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system comprising:
a first low noise amplifier configured to output a first amplified analog signal based on a received analog antenna signal at a time t₀;
a second low noise amplifier configured to output a second amplified analog signal based on the received analog antenna signal at a time t₁;
a local oscillator configured to output a local analog oscillator signal;
a signal splitter configured to output a first split analog oscillator signal and a second split analog oscillator signal, the first split analog oscillator signal being based on the local analog oscillator signal, the second split analog oscillator signal being based on the local analog oscillator signal and being different from the first split analog oscillator signal;
a first mixer configured to output a first mixed signal based on the first amplified analog signal and the first split analog oscillator signal;
a second mixer configured to output a second mixed signal based on the second amplified analog signal and the second split analog oscillator signal;
an analog to digital converter configured to output a combined digital signal based on the first mixed signal and the second mixed signal;
a digital channelizer and beam-former configured to output a received signal based on the combined digital signal; and
a phase error correcting component configured to generate a first phase error correction coefficient and a second phase error correction coefficient, wherein said digital channelizer and beam-former comprises a polyphase filter and a time division multiplexer, wherein said polyphase filter is configured to receive the combined digital signal, to output a first filtered signal having a first frequency and to output a second filtered signal having a second frequency,
wherein said polyphase filter is further configured to receive the first phase error correction coefficient and to output a first modified filtered signal based on the first phase effort correction coefficient and the first filtered signal,
wherein said polyphase filter is further configured to receive the second phase error correction coefficient and to output a second modified filtered signal based on the second phase effort correction coefficient and the second filtered signal, and
wherein said time division multiplexer is configured to output a beam-formed received signal based on the first modified filtered signal and the second modified filtered signal.

2. The system of claim 1, wherein said a phase error correcting component comprises:
a phase error correction coefficient generator operable to generate the first phase error correction coefficient and the second phase error correction coefficient;
a known phase error correction coefficient generator operable to generate a known first phase error correction coefficient and a known second phase error correction coefficient; and
a comparator operable to generate a compared signal based on a comparison of the beam-formed signal with a known beam-formed signal that is based on the known first phase error correction coefficient and the known second phase error correction coefficient.

3. The system of claim 2, wherein said phase error correction coefficient generator is further operable to generate a new first phase error correction coefficient and new second phase error correction coefficient when the compared signal is below a predetermined threshold.

4. The system of claim 3, wherein said phase error correction coefficient generator, said known phase error correction coefficient generator and said comparator are arranged as an adaptive feedback system to minimize the compared signal.

5. The system of claim 4, wherein a phase error correcting component is configured to generate the first phase error correction coefficient as a complex coefficient.

6. The system of claim 5, wherein said digital channelizer and beam-former comprises an inverse fast Fourier transform component.

7. The system of claim 3, wherein a phase error correcting component is configured to generate the first phase error correction coefficient as a complex coefficient.

8. The system of claim 7, wherein said digital channelizer and beam-former comprises an inverse fast Fourier transform component.

9. The system of claim 2, wherein a phase error correcting component is configured to generate the first phase error correction coefficient as a complex coefficient.

10. The system of claim 9, wherein said digital channelizer and beam-former comprises an inverse fast Fourier transform component.

11. The system of claim 1, wherein a phase error correcting component is configured to generate the first phase error correction coefficient as a complex coefficient.

12. The system of claim 11, wherein said digital channelizer and beam-former comprises an inverse fast Fourier transform component.

13. A method comprising:
outputting, via a first low noise amplifier, a first amplified analog signal based on a first received analog driving signal;
outputting, via a second low noise amplifier, a second amplified analog signal based on a second received analog driving signal;
outputting, via a local oscillator, a local analog oscillator signal;
outputting, via a signal splitter, a first split analog oscillator signal and a second split analog oscillator signal, the first split analog oscillator signal being based on the local analog oscillator signal, the second split analog oscillator signal being based on the local analog oscillator signal and being different from the first split analog oscillator signal;
outputting, via a first mixer, a first mixed signal based on the first amplified signal and the first split oscillator signal;
outputting, via a second mixer, a second mixed signal based on the second amplified signal and the second split oscillator signal;
outputting, via an analog to digital converter, a combined digital signal based on the first mixed signal and the second mixed signal; and
outputting, via a digital channelizer and beam-former, a driving signal based on the combined digital signal;
generating, via a phase error correcting component, a first phase error correction coefficient and a second phase error correction coefficient,
wherein said outputting, via the digital channelizer and beam-former, the driving signal based on the combined digital signal comprises:
receiving, via a polyphase filter, the combined digital signal;
outputting, via the polyphase filter, a first filtered signal having a first frequency;
outputting, via the polyphase filter, a second filtered signal having a second frequency;
outputting, via an inverse Fourier transform component, a first transformed signal based on the first filtered signal;
outputting, via the inverse Fourier transform component, a second transformed signal based on the second filtered signal; and
outputting, via a time division multiplexer, a received signal based on the first transformed signal and the second transformed signal.

14. The method of claim 13, further comprising generating, via the phase error correcting component, a compared signal based on a difference of the received signal and a known signal.

15. The method of claim 14, wherein the compared signal has a first state when an absolute value of the difference between the received signal and the known signal is less than or equal to a predetermined threshold.

16. The method of claim 14, further comprising generating, via the phase error correcting component, third first phase error correction coefficient and fourth second phase error correction coefficient when the absolute value of the difference between the received signal and the known signal is greater than the predetermined threshold.

17. A non-transitory, tangible, computer-readable media having computer-readable instructions stored thereon, the computer-readable instructions being capable of being read by a computer and being capable of instructing the computer to perform the method comprising:
outputting, via a first low noise amplifier, a first amplified analog signal based on a first received analog driving signal;
outputting, via a second low noise amplifier, a second amplified analog signal based on a second received analog driving signal;
outputting, via a local oscillator, a local analog oscillator signal;
outputting, via a signal splitter, a first split analog oscillator signal and a second split analog oscillator signal, the first split analog oscillator signal being based on the local analog oscillator signal, the second split analog oscillator signal being based on the local analog oscillator signal and being different from the first split analog oscillator signal;
outputting, via a first mixer, a first mixed signal based on the first amplified signal and the first split oscillator signal;
outputting, via a second mixer, a second mixed signal based on the second amplified signal and the second split oscillator signal;
outputting, via an analog to digital converter, a combined digital signal based on the first mixed signal and the second mixed signal; and
outputting, via a digital channelizer and beam-former, a driving signal based on the combined digital signal;
generating, via a phase error correcting component, a first phase error correction coefficient and a second phase error correction coefficient,
wherein said outputting, via the digital channelizer and beam-former, the driving signal based on the combined digital signal comprises:
receiving, via a polyphase filter, the combined digital signal;
outputting, via the polyphase filter, a first filtered signal having a first frequency;
outputting, via the polyphase filter, a second filtered signal having a second frequency;
outputting, via an inverse Fourier transform component, a first transformed signal based on the first filtered signal;
outputting, via the inverse Fourier transform component, a second transformed signal based on the second filtered signal; and
outputting, via a time division multiplexer, a received signal based on the first transformed signal and the second transformed signal.

18. The non-transitory, tangible, computer-readable media of claim 17, wherein the computer-readable instructions are capable of instructing the computer to perform the method further comprising generating, via the phase error correcting component, a compared signal based on a difference of the received signal and a known signal.

19. The non-transitory, tangible, computer-readable media of claim 18, wherein the computer-readable instructions are capable of instructing the computer to perform the method such that the compared signal has a first state when an absolute value of the difference between the received signal and the known signal is less than or equal to a predetermined threshold.

20. The non-transitory, tangible, computer-readable media of claim 19, wherein the computer-readable instructions are capable of instructing the computer to perform the method further comprising generating, via the phase error correcting component, third first phase error correction coefficient and fourth second phase error correction coefficient when the absolute value of the difference between the received signal and the known signal is greater than the predetermined threshold.
